(19) United States
(12) Patent Application Publication
(10) Pub. No.: US 2025/0247730 A1
(43) Pub. Date: Jul. 31, 2025

(54) SYSTEMS AND METHODS FOR ADAPTIVE USE OF MEASUREMENT GAPS

(71) Applicant: Meta Platforms Technologies, LLC, Menlo Park, CA (US)

(72) Inventors: Liwen Yu, Santa Clara, CA (US); Curt Wong, Bellevue, WA (US); Zhu Ji, Cupertino, CA (US)

(73) Assignee: Meta Platforms Technologies, LLC, Menlo Park, CA (US)

(21) Appl. No.: 19/015,601

(22) Filed: Jan. 9, 2025

Related U.S. Application Data
(60) Provisional application No. 63/627,404, filed on Jan. 31, 2024.

(51) Int. Cl. H04W 24/10

(52) U.S. Cl. CPC H04W 24/10

(57) ABSTRACT

Systems and methods for adaptive use of measurement gaps may include a wireless communication device which transmits, via a transceiver to a wireless communication node, a report comprising one or more conditions of the wireless communication device. The wireless communication device may receive, via the transceiver from the wireless communication node, an indication based on the one or more conditions, and selectively skip at least a portion of a measurement gap of a radio resource management (RRM) measurement, according to the indication.

### CROSS-REFERENCE TO RELATED APPLICATIONS

This application claims the benefit of and priority to U.S. Provisional Application No. 63/627,404, filed Jan. 31, 2024, the contents of which are incorporated herein by reference in their entirety.

### FIELD OF DISCLOSURE

The present disclosure is generally related to wireless communication between devices, including but not limited to, systems and methods for adaptive use of measurement gaps.

### BACKGROUND

Augmented reality (AR), virtual reality (VR), and mixed reality (MR) are becoming more prevalent, which such technology being supported across a wider variety of platforms and device. Some devices may be supported through cellular communications.

### SUMMARY

In one aspect, this disclosure relates to a method. The method may include transmitting, by a wireless communication device to a wireless communication node, a report including one or more conditions of the wireless communication device. The method may include receiving, by the wireless communication device from the wireless communication node, an indication based on the one or more conditions. The method may include selectively skipping, by the wireless communication device, at least a portion of a measurement gap of a radio resource management (RRM) measurement, according to the indication.

In some embodiments, the one or more conditions include at least one of cellular conditions of the wireless communication device, movement data of the wireless communication device satisfying a threshold criterion, or a priority of traffic of the wireless communication device. In some embodiments, transmitting the report is responsive to determining to transmit traffic to the wireless communication node. In some embodiments, the traffic includes extended reality (XR) traffic, and the method further includes determining, by the wireless communication device, at least one quality of service (QOS) metric of the XR traffic, the QoS metric including at least one of a time sensitivity, a data rate, or reliability metric. The method may include transmitting, by the wireless communication device, the report responsive to the QoS metric satisfying a threshold criterion.

In some embodiments, the method further includes transmitting, by the wireless communication device, traffic to the wireless communication node during the portion of the measurement gap, responsive to skipping the portion. In some embodiments, the method further includes transmitting, by the wireless communication device, the report responsive to determining to transmit traffic and at least one of the following: the traffic has a packet delay budget (PDB) less than a threshold PDB; the traffic has a data rate which is greater than a threshold data rate; the traffic has a packet loss rate which is less than a threshold packet loss rate; the traffic has an importance level which is greater than a threshold importance; a location of the wireless communication device is associated with a central portion of a coverage area of the wireless communication node; or a movement of the wireless communication device is less than a threshold mobility.

In some embodiments, selectively skipping the portion of the measurement gap includes reducing a gap duration or a periodicity of a measurement gap pattern. In some embodiments, selectively skipping the portion of the measurement gap includes deactivating the measurement gap. In some embodiments, the method further includes identifying, by the wireless communication device, for a plurality of protocol data unit (PDU) sets, an importance of the respective PDU sets, to be sent to the wireless communication node; and selectively skipping, by the wireless communication device, at least a portion of a measurement gap, responsive to the importance of at least one PDU set being greater than a threshold. In some embodiments, the wireless communication device skips the portion of the measurement gap responsive to the at least one PDU set being in a buffer for transmission uplink, and the portion of the measurement gap which is skipped by the wireless communication corresponds to a time instance in which the PDU set is sent uplink.

In another aspect, this disclosure relates to a wireless communication device, including a transceiver, and one or more processors configured to transmit, via the transceiver to a wireless communication node, a report including one or more conditions of the wireless communication device. The one or more processors may be configured to receive, via the transceiver from the wireless communication node, an indication based on the one or more conditions. The one or more processors may be configured to selectively skip at least a portion of a measurement gap of a radio resource management (RRM) measurement, according to the indication.

In some embodiments, the one or more conditions include at least one of cellular conditions of the wireless communication device, movement data of the wireless communication device satisfying a threshold criterion, or a priority of traffic of the wireless communication device. In some embodiments, transmitting the report is responsive to determining to transmit traffic to the wireless communication node. In some embodiments, the traffic includes extended reality (XR) traffic, wherein the one or more processors are further configured to determine at least one quality of service (QOS) metric of the XR traffic, the QoS metric including at least one of a time sensitivity, a data rate, or reliability metric; and transmit the report responsive to the QoS metric satisfying a threshold criterion.

In some embodiments, the one or more processors are configured to transmit, via the transceiver, traffic to the wireless communication node during the portion of the measurement gap, responsive to skipping the portion. In some embodiments, the one or more processors are further configured to transmit the report responsive to determining to transmit traffic and at least one of the following: the traffic having a packet delay budget (PDB) less than a threshold PDB; the traffic having a data rate which is greater than a threshold data rate; the traffic having a packet loss rate which is less than a threshold packet loss rate; the traffic having an importance level which is greater than a threshold importance; a location of the wireless communication device is associated with a central portion of a coverage area of the wireless communication node; or a movement of the wireless communication device is less than a threshold mobility.

In some embodiments, selectively skipping the portion of the measurement gap includes reducing a gap duration or a periodicity of a measurement gap pattern. In some embodiments, selectively skipping the portion of the measurement gap includes deactivating the measurement gap. In some embodiments, the one or more processors are further configured to: identify, for a plurality of protocol data unit (PDU) sets, an importance of the respective PDU sets, to be sent to the wireless communication node; and selectively skip at least a portion of a measurement gap, responsive to the importance of at least one PDU set being greater than a threshold.

In yet another aspect, this disclosure relates to a non-transitory computer readable medium storing instructions that, when executed by one or more processors, cause the one or more processors to transmit, via a transceiver to a wireless communication node, a report including one or more conditions of the wireless communication device. The instructions may further cause the processor(s) to receive, via the transceiver from the wireless communication node, an indication based on the one or more conditions. The instructions may further cause the processor(s) to selectively skip at least a portion of a measurement gap of a radio resource management (RRM) measurement, according to the indication.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a measurement gap pattern, according to an example implementation of the present disclosure.

FIG. 6 is a block diagram of a system for adaptive use of measurement gaps, according to an example implementation of the present disclosure.

FIG. 7 is a measurement gap pattern with adaptive use of measurement gaps, according to an example implementation of the present disclosure.

FIG. 8 is a measurement gap pattern with adaptive use of measurement gaps, according to another example implementation of the present disclosure.

FIG. 9 is a measurement gap pattern with adaptive use of measurement gaps, according to another example implementation of the present disclosure.

FIG. 10 a diagram showing adaptive use of measurement gaps for protocol data unit sets, according to another example implementation of the present disclosure.

FIG. 11 is a flowchart showing an example method for adaptive use of measurement gaps, according to another example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

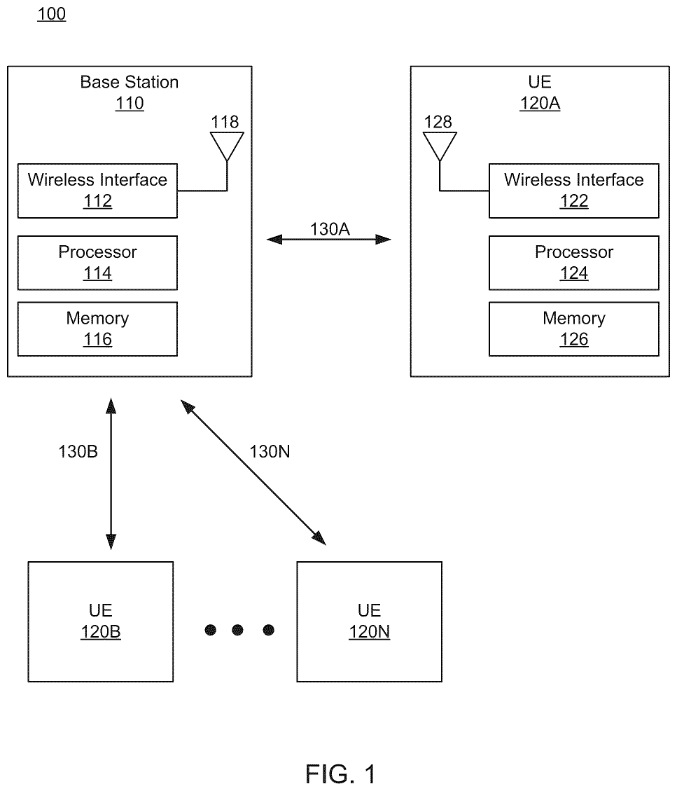

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

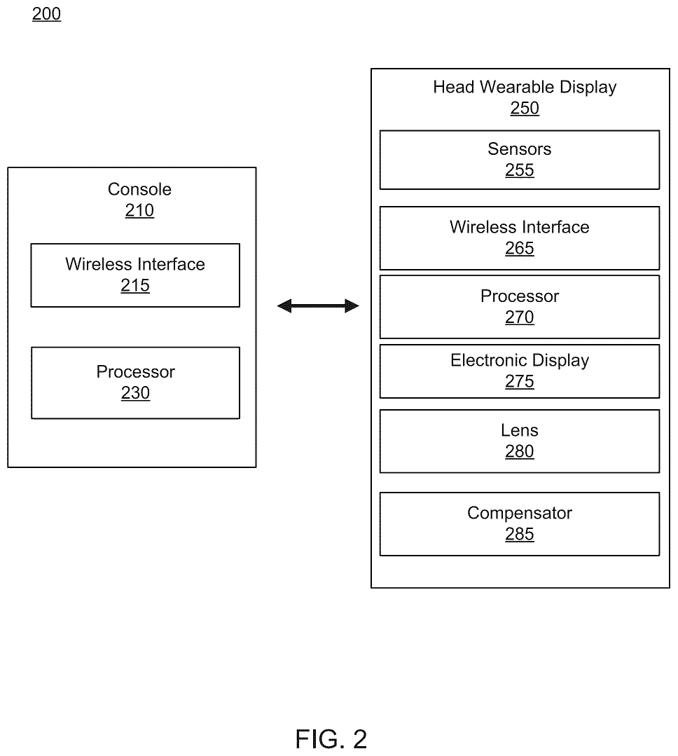

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the

HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

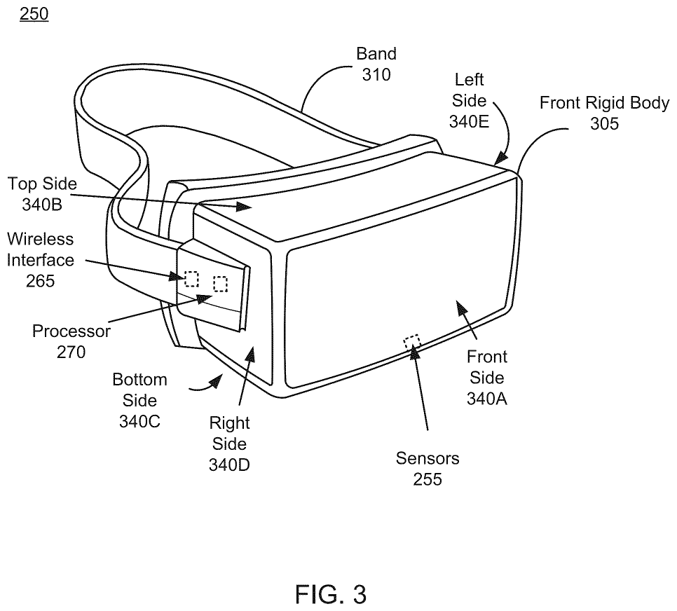

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

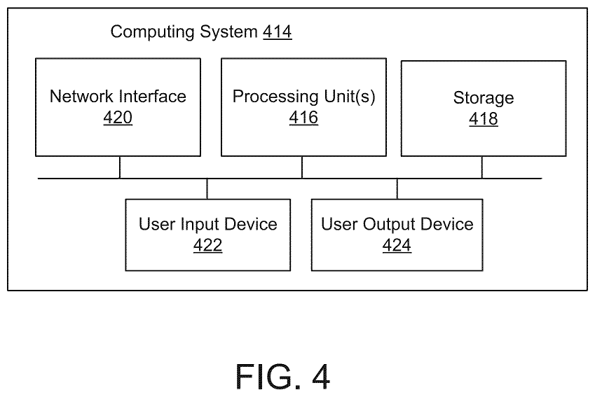

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

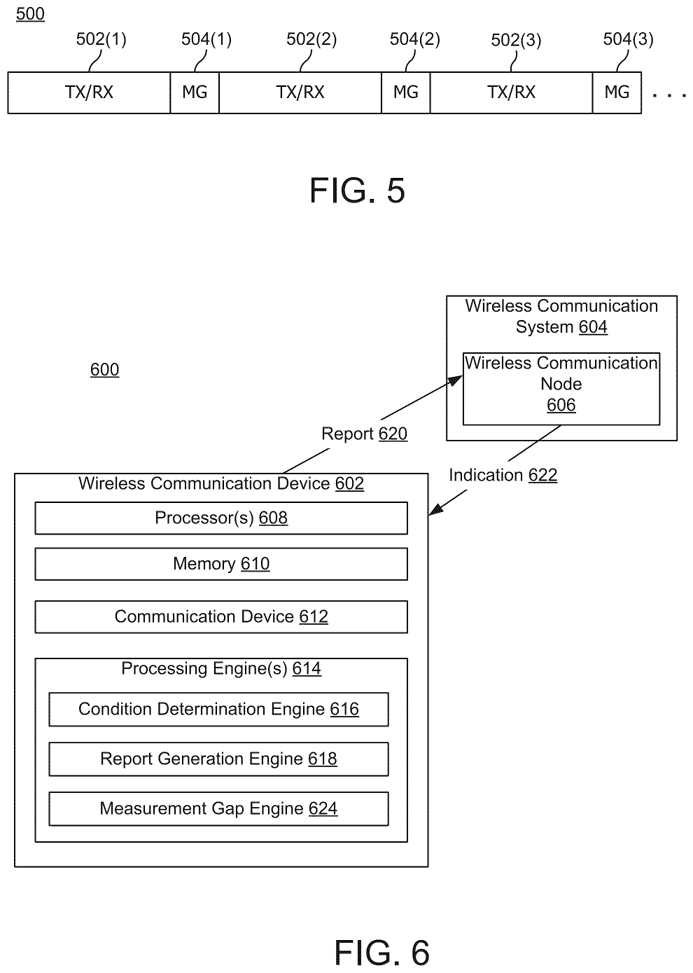

Referring now to FIG. 5, depicted is a measurement gap pattern 500, which may be specified for periodic measurements by a user equipment. In particular, a measurement gap may be defined and used for periodic measurements, without adaptation or dynamic activation/deactivation. Measurement gaps (MGs) may allow user equipment (UE) to perform radio resource management (RRM) measurements without interfering with data transmission and reception. As shown in FIG. 5, the measurement gap pattern 500 may include transmission and reception periods 502(1)-502(3), with periodic measurement gap periods 504(1)-504(3). However, a MG can cause capacity and latency performance degradation for extended reality (XR) users, which may lead to unmet quality of service (QOS) requirements and discarded protocol data units (PDUs). This problem is particularly severe for XR multi-modal flows, which may involve more frequent scheduling and transmissions than single flow traffic. On the other hand, RRM measurements may be beneficial to UEs, especially at the cell edge or when the UE has high mobility. These measurements may facilitate the network to optimize beam selection and mobility, ensuring good QoS for all UEs.

According to various implementations, the systems and methods described herein may provide a dynamic and adaptive MG configuration and activation/deactivation mechanism for XR user devices (or wireless communication devices), which minimizes impact on capacity and latency performance while retaining good RRM measurement quality. For example, and according to the systems and methods described herein, a wireless communication device may report on various conditions of the device (such as conditions of XR multi-modal flows, the wireless communication device, cell signal or strength thereof, etc.). The wireless communication device my report the conditions to a base station or other wireless communication node. Based on a corresponding indication from the base station, the wireless communication device can selectively skip certain measurement gap periods (or portions thereof) to provide XR traffic, while still performing measurements in a manner which minimizes the impact on other UEs/the UEs QoS requirements. By addressing this challenge, the systems and methods described herein can improve the overall performance of cellular networks for XR users while maintaining good QoS for all UEs.

In certain implementations of the present disclosure, the systems and methods described herein may dynamically activate and deactivate MGs based on various conditions of the UE. For example, such conditions may be or include low mobility, strong cell signal, high priority traffic, etc. The UE may report to a base station certain conditions of the UE (e.g., to request skipping a measurement gap). The base station may provide an indication to the UE (e.g., to approve/deny of skipping a portion of/the entirety of a measurement gap). In this regard, when a MG deactivation condition is met, the MG can be deactivated. On the other hand, in instances where the MG deactivation condition is not met, a MG configuration may be applied. By implementing such implementations, the systems and methods described herein can minimize XR transmission interruptions while ensuring that UEs which may leverage RRM measurements receive those measurements.

In certain implementations of the present disclosure, the systems and methods described herein may implement an adaptive MG pattern. The MG pattern may include a periodicity and a gap duration. The gap duration and periodicity may be adaptive to minimize capacity and latency loss. The gap duration and periodicity may be determined based on the UE's location, mobility, and XR traffic requirements (e.g., the condition(s) of the UE). In certain implementations of the present disclosure, the systems and methods described herein may implement a coordinated PDU set transmission and MG adaptation based on importance of PDU sets (or PDUs within a PDU set).

Referring now to FIG. 6, depicted is a block diagram of a system 600 for adaptive use of measurement gaps, according to an example implementation of the present disclosure. The system 600 may include a wireless communication device 602 communicably coupled to a wireless communication system 604 including a wireless communication node 606. The wireless communication device 602 may be similar to the user equipment 120, console 210, and/or head wearable display 250 described above with reference to FIG. 1-FIG. 4. The wireless communication node 606 may be, include, or be similar to the base station 110 described above with reference to FIG. 1.

The wireless communication device 602 may one or more processors 608, memory 610, and a communication device 612. While shown as included on the wireless communication device 602, in various embodiments, the wireless communication system 604 (including the components/elements/wireless communication nodes 606 thereof) may similarly include processor(s), memory, and a communication device. The processor(s) 608 may be the same as or similar to the processors 114, 124, 230, 270 and/or processing unit(s) 416 described above with reference to FIG. 1-FIG. 4. The memory 610 may be the same as or similar to memory 116, 126, and/or storage 418 described above with reference to FIG. 1-FIG. 4. The communication device 612 may be the same as or similar to the wireless interface 112, 122, 215, 265 (e.g., in combination with or communicably coupled to antenna 118, 128) and/or network interface 420 described above with reference to FIG. 1-FIG. 4.

The wireless communication device 602 may include one or more processing engines 614. The processing engine(s) 614 may be or include any device, component, element, or hardware designed or configured to perform one or more of the functions described herein. The processing engine(s) 614 may include a condition determination engine 616, a report generation engine 618, and a measurement gap engine 624. While these processing engine(s) 614 are shown and described herein, it should be understood that additional and/or alternative processing engine(s) 614 may be implemented on the application server 504. Additionally, two or more of the processing engine(s) 614 may be implemented as a single processing engine 614. Furthermore, one of the processing engine(s) 614 may implemented as multiple processing engines 614.

The condition determination engine 616 may be designed or configured to detect, determine, or otherwise identify one or more conditions of the device. The condition may be or include a cellular condition of the device, movement data of the device, traffic-related information of the device, and so forth. Each of such conditions are described in greater detail below.

The condition determination engine 616 may be configured to determine a cellular condition of the device 602. In some embodiments, the condition determination engine 616 is configured to determine cellular conditions of the wireless communication device 602 by processing data received from one or more components of the device 602 (such as the communication device 612, including but not limited to the radio frequency (RF) front end, modem, and/or location services). For example, the condition determination engine 616 may be configured to determine the proximity of the device 602 to a central portion of a cellular coverage area. The condition determination engine 616 may be configured to determine the proximity of the device 602 to the central portion of the cell coverage area of the wireless communication node 606, based on various parameters including, but not limited to, signal strength, signal-to-noise ratio (SNR), and timing advance (TA) values associated with communications between the device 602 and a serving base station. For instance, a relatively strong signal strength and a relatively small TA value may indicate that the device 602 is located nearer to the central portion of the coverage area, whereas a relatively weak signal strength and a larger timing advance may indicate that the device 602 is closer to a peripheral region of the coverage area. In some embodiments, the condition determination engine 616 may be configured to determine, detect, or otherwise identify additional and/or alternative cellular conditions, such as levels of interference from neighboring cells, connection quality metrics (e.g., packet error rate or bit error rate), or channel quality indicators (CQIs).

In some embodiments, the condition determination engine 616 may be configured to determine a movement condition of the device 602. The movement condition may be or include intra-cell movement conditions and/or inter-cell movement conditions. Intra-cell movement conditions may be or include movement of the wireless communication device 602 within the coverage area of a cell which may not impact cell association or connection with the base station (e.g., small-scale displacements or shifts, local movements, etc.). Inter-cell movements may be or include movement of the wireless communication device 602 which may result in a transition from the coverage area of one cell to another, such as when the device 602 moves towards the boundary of a serving cell, moves into the boundary of another neighboring cell, etc.

The condition determination engine 616 may be configured to determine a movement condition of the device 602 by analyzing data from various sensors and communication metrics (e.g., cellular conditions). To determine intra-cell movements, the condition determination engine 616 may be configured to receive various inputs/signals/measurements from various motion sensors (e.g., on the wireless communication device 602 or on another device communicably coupled to the wireless communication device 602 and worn/held/used by an end user). The motion sensors may be or include an accelerometer or gyroscope. The condition determination engine 616 may be configured to detect movement of the device 602 within the coverage area of the current cell, based on or according to the sensor data from the motion sensor(s). In some embodiments, the condition determination engine 616 may be configured to process variations in cellular conditions (e.g., signal strength or angle of arrival from the serving base station) to detect, identify, determine, or otherwise infer changes in the relative position of the device 602 within the cell.

In some embodiments, to determine inter-cell movements, the condition determination engine 616 may be configured to detect, identify, track, or otherwise monitor changes in cellular conditions over time. For example, the condition determination engine 616 may be configured to monitor changes in signal quality and timing advance values over time. The condition determination engine 616 may be configured to determine a relative movement of the wireless communication device 602 with respect to the base station 606, based on changes in the cellular conditions. For example, where signal strength decreases and/or the TA value increases over time, the condition determination engine 616 may be configured to determine that the wireless communication device 602 is moving away from the serving base station and toward the boundary of the current cell. Similarly, where signal strength increases and/or the TA value decreases over time, the condition determination engine 616 may be configured to determine that the wireless communication device 602 is moving towards the center/central portion of the cellular coverage area of the serving base station. In some embodiments, the condition determination engine 616 may may be configured to use location data, such as coordinates from a global positioning system (GPS) sensor or hardware of the wireless communication device 602, to determine the velocity and trajectory of the device 602. Based on various combinations of such inputs, the condition determination engine 616 may identify movement patterns that indicate, identify, or otherwise project inter-cell movement. time sensitivity, a data rate, or reliability metric.

In some embodiments, the condition determination engine 616 may be configured to determine a condition of traffic of the wireless communication device. The condition may be or include a priority (e.g., a time sensitivity) of the traffic (e.g., of protocol data unit (PDU) sets, individual PDUs, traffic types, etc.), data rate, or a reliability metric (e.g., a packet loss rate, and/or importance level). The condition determination engine 616 may be configured to determine traffic priority by analyzing parameters associated with protocol data unit (PDU) sets, individual PDUs, or specific traffic types. For example, the condition determination engine 616 may be configured to identify traffic categories based on applications/resources/services executing on/supported by the wireless communication device 602, and assign a priority level based on the application. For example, for certain applications, such as voice over internet protocol (VOIP), video conferencing, or real-time gaming applications, the condition determination engine 616 may be configured to assign higher priority to certain types of traffic (e.g., voice, audio, video, etc.) which may have low latency support specifications.

In some embodiments, the condition determination engine 616 may be configured to determine the data rate of traffic by monitoring throughput metrics, such as bits per second (bps) or average transmission rates over a defined interval. The condition determination engine 616 may be configured to classify the traffic based on the throughput metrics (e.g., high-bandwidth streaming, low-bandwidth signaling, or intermittent data bursts). In some embodiments, the condition determination engine 616 may be configured to determine a packet loss rate, by analyzing acknowledgment signals, negative acknowledgment signals, and retransmission counts within one or more layers of the protocol stack, such as the physical layer or transport layer. In some embodiments, the condition determination engine 616 may be configured to determine an importance level for traffic by determining application-specific parameters, quality-of-service (QoS) profiles, or priority markers incorporated in a data stream, such as Differentiated Services Code Points (DSCP) in an IP header, 5G QoS identifiers (5Q1) for a particular data pipeline of the session, etc.

The report generation engine 618 may be designed or configured to determine, configure, establish, produce, or otherwise generate a report 620 identifying the condition(s) by the condition determination engine 616. In some embodiments, the report generation engine 618 may be configured to generate the report 620, responsive to identifying, determining, or otherwise detecting traffic is to be sent by the wireless communication device 602 to the wireless communication node 606. In some implementations, the report generation engine 618 may be configured to detect traffic is to be sent by the wireless communication device 602 based on based on a notification or trigger from the protocol stack of the wireless communication device 602. For example, the report generation engine 618 may be configured to detect and analyze signals or events from the application layer, transport layer, or other communication layers to identify an impending data transmission. In some implementations, the report generation engine 618 may be configured to monitor buffers within the device 602 for the presence of data awaiting transmission. For instance, the report generation engine 618 may evaluate the size, type, or priority of data queued in a transmission buffer to determine whether a report 620 should be generated. In some implementations, the report generation engine 618 be configured to detect that traffic is to be sent by evaluating control signals or scheduling grants from the wireless communication node 606. For example, when the wireless communication node 606 provides a scheduling assignment or uplink grant to the wireless communication device 602, the report generation engine 618 may be configured to determine that traffic is expected to be transmitted and generate the report 620 accordingly.

In some embodiments, the report generation engine 618 may be configured to generate the report 620 responsive to determining that traffic is to be transmitted to the wireless communication node 606, and based on the condition(s) of the device 602 satisfying one or more threshold criterion. For example, the report generation engine 618 may be configured to generate the report 620, to request skipping the measurement gap (or a portion thereof), when traffic is to be transmitted to the wireless communication node 606, and the condition(s) of the device 602 indicate that QoS of the device 602 and/or other devices may not be as impacted by skipping the measurement gap, as compared to delaying transmission of the traffic. Various examples of the conditions and corresponding technical benefits are provided below.

As one example, the report generation engine 618 may be configured to generate the report 620, responsive to the traffic having a packet delay budget (PDB) which less than a threshold PDB. This may allow the wireless communication device 602 to prioritize latency-sensitive traffic by skipping a measurement gap, ensuring timely transmission of data for applications, such as voice over IP (VOIP) or real-time video streaming. As another example, the report generation engine 618 may be configured to generate the report 620 responsive to the traffic having a data rate that is greater than a threshold data rate. This may facilitate uninterrupted data transfer for high-bandwidth applications, such as large file uploads or high-definition video streaming, by facilitating the wireless communication device 602 to skip a portion of the measurement gap and instead allocate resources efficiently and maintain consistent throughput. As yet another example, the report generation engine 618 may be configured to generate the report 620 responsive to the traffic having a packet loss rate that is less than a threshold packet loss rate. This condition may indicate stable network conditions, allowing the wireless communication device 602 to skip a measurement gap without adversely impacting the quality or reliability of the ongoing communication session. As another example, the report generation engine 618 may be configured to generate the report 620 responsive to the traffic having an importance level that is greater than a threshold importance. This may ensure timely and uninterrupted transmission of higher importance data, such as emergency alerts, system updates, or high-priority application messages, and correspondingly adapting the measurement gap usage accordingly. As still another example, the report generation engine 618 may be configured to generate the report 620 responsive to the location of the wireless communication device 602 being associated with a central portion of the coverage area of the wireless communication node 606. In this example, the wireless communication device 602 may benefit from strong signal quality and low interference, allowing the measurement gap to be skipped while maintaining strong network connectivity. As a further example, the report generation engine 618 may be configured to generate the report 620 responsive to the movement of the wireless communication device 602 being less than a threshold mobility. A low-mobility condition may indicate that the device 602 is stationary or moving slowly, reducing the likelihood of a handover and thereby permitting the wireless communication device 602 to skip the measurement gap without compromising communication reliability or quality.

The wireless communication device 602 may be configured to transmit (e.g., via the communication device 612) the report 620 to the wireless communication node 606. The report 620 may include information about one or more conditions of the device 602 and/or the traffic to be transmitted, such as traffic priority, data rate, packet loss rate, packet delay budget (PDB), location within the coverage area, and/or mobility level. In some embodiments, the wireless communication device 602 may be configured to transmit the report 620 in various types/forms of signals or messages, such as, but not limited to, radio resource control (RRC) messages, uplink control information (UCI) messages, non-access stratum (NAS) messages, scheduling requests, etc.

In some embodiments, the wireless communication node 606 and/or the wireless communication system 604 may be configured to analyze the report 620 to determine whether to permit the wireless communication device 602 to skip a portion of the measurement gap. For example, the wireless communication node 606 may be configured to evaluate the conditions reported by the device 602 in the context of current network policies, traffic priorities, and resource availability. In some embodiments, the wireless communication node 606 and/or the wireless communication system 604 (e.g., the core network) may be configured to analyze the report 620. For example, and in some embodiments, an Access and Mobility Management Function (AMF) may be configured to analyze the report 620 to assess mobility-related aspects, such as whether skipping the measurement gap would interfere with handover processes. As another example, the User Plane Function (UPF) may be configured to analyze the report 620 to ensure compliance with QoS requirements.

The wireless communication node 606 and/or core network (generally referred to as the wireless communication node 606) may be configured to generate, define, establish, or otherwise configure an indication 622 based on the report 620. The wireless communication node 606 may be configured to configure the indication 622 based on the condition(s) indicated by the report, to indicate whether the wireless communication device 602 can skip a portion of the measurement gap. In some embodiments, the indication 622 may include explicit instructions, such as a command to skip the measurement gap entirely, to skip a portion of the measurement gap (e.g., an initial or final segment, to reduce a duration of the measurement gap), or to proceed without any modifications to the measurement gap. The indication 622 may take the form of a control message transmitted over a signaling channel, a scheduling grant with specific parameters, or a flag appended to a communication protocol message.

The wireless communication device 602 may be configured to receive (e.g., via the communication device 612) an indication 622 from the wireless communication node 606 and/or the core network. The measurement gap engine 624 may be designed or configured to manage a measurement gap pattern. In some embodiments, the measurement gap engine 624 may be configured to manage the measurement gap pattern based on the indication 622 received from the wireless communication system 604 (e.g., from the wireless communication node 606, which may be generated by the wireless communication node 606 and/or by a different entity/function of the wireless communication system 604). The measurement gap engine 624 may be configured to selectively skip portion(s) of a measurement gap of a radio resource management (RRM) measurement, according to the indication 622. The measurement gap engine 624 may be configured to selectively skip portion(s) of a measurement gap, by reducing a gap duration (e.g., reducing a duration of the measurement gap), by reducing a periodicity of the measurement gap (e.g., performing less frequent RRM measurements in respective measurement gaps), and/or deactivating a particular instance of a measurement gap. The measurement gap engine 624 may be configured to selectively skip portion(s) of the measurement gap, to instead transmit traffic to the wireless communication node during those skipped portion(s).

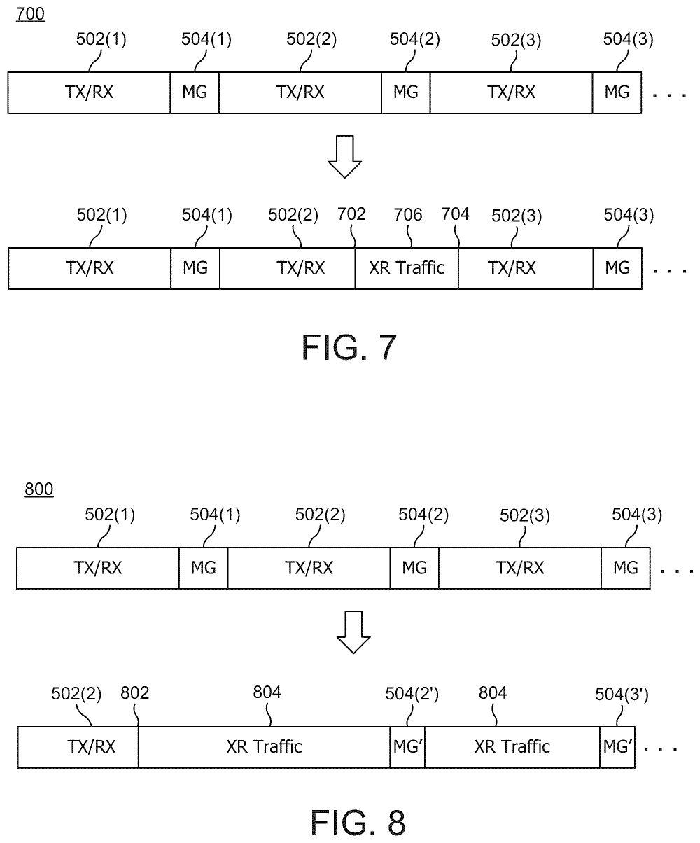

Referring now to FIG. 7-FIG. 9, depicted are various examples 700-900 of modifications to measurement gap pattern(s) (such as the measurement gap pattern 500 described above), that may be made by the measurement gap engine 624, according to example implementations of the present disclosure. In each of the figures, the measurement gap pattern 500 as provided in FIG. 5, is shown for comparison against adaptive use of the measurement gap that may be implemented by the measurement gap engine 624, according to various example implementations described herein.

Beginning with FIG. 7, in this example 700, the measurement gap engine 624 may be configured to skip the second measurement gap 504(2), by deactivating the measurement gap (e.g., at a first time instance 702) and reactivate the measurement gap (e.g., at a second time instance 704). As shown in FIG. 7, the second measurement gap 504(2) may be between the first time instance 702 and the second time instance 704. While the measurement gap 504(2) is deactivated, the wireless communication device 602 may instead transmit various traffic (e.g., XR traffic 706) to the wireless communication node 606, instead of performing one or more RRM measurements during the measurement gap 504(2). However, once the measurement gap is reactivated (e.g., at the second time stance), the wireless communication device 602 may resume the measurement gap pattern.

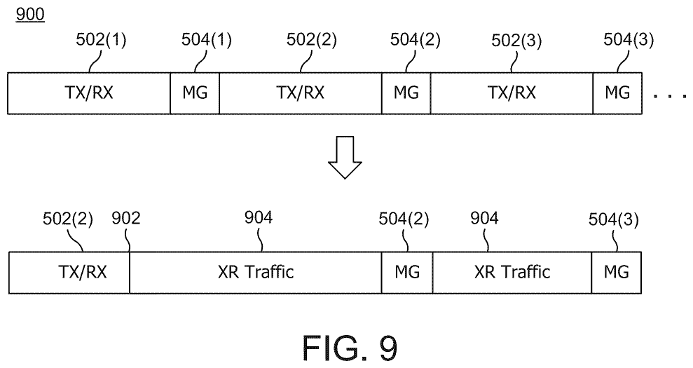

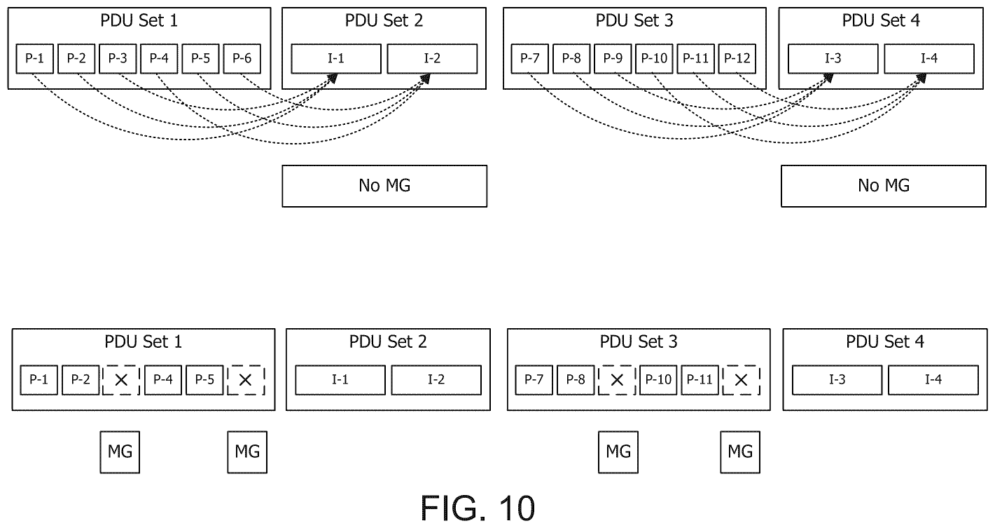

In the example 800 of FIG. 8, the measurement gap engine 624 may be configured to skip the first measurement gap 504(1), by deactivating the measurement gap (e.g., at a first time instance 802). As shown in FIG. 8, the first measurement gap 504(1) may commence subsequent to the first time instance 802. While the measurement gap is deactivated, the wireless communication device 602 may instead transmit various traffic (e.g., XR traffic 804) to the wireless communication node 606. In this example, rather than skipping an entirety of additional measurement gaps, the measurement gap engine 624 may be configured to skip portions of subsequent measurement gaps (e.g., to provide for a reduced duration measurement gap 504(2′), 504(3′)). In the example 900 of FIG. 9, the measurement gap engine 624 may be configured to skip the first measurement gap 504(1) similar to the example 800 above (e.g., by deactivating the measurement gap at a first time instance 902, and instead transmitting XR traffic 904). However, instead of reducing portions of the measurement gap, the measurement gap engine 624 may be configured to maintain the duration of subsequent measurement gaps 504(2), 504(3), with intermittent transmission of XR traffic 904.

Referring now to FIG. 10, depicted is a diagram 1000 showing adaptive use of measurement gaps for protocol data unit (PDU) sets, according to another example implementation of the present disclosure. In other words, and in various embodiments, the measurement gap engine 624 may be configured to adaptively use the measurement gap based on traffic conditions of all traffic, and/or based on traffic conditions of PDU sets and/or individual PDUs. For example, as shown in FIG. 10, four PDU sets may include various combinations of PDUs (e.g., P-1 through P-6 in a first PDU set, I-1 through I-2 in a second PDU set, P-7 through P-12 in a third PDU set, and I-3 through I-4 in a fourth PDU set). For high importance PDU sets (e.g., those shown in the second and fourth PDU sets, which may have a higher importance level, may have dependency on the contents of other PDUs, etc.), the measurement gap engine 624 may be configured to disable the measurement gap for time instances or periods in which the high importance PDU sets can be sent. Additionally, for remaining PDUs or PDU sets (e.g., the first PDU set and the third PDU set), the measurement gap engine 624 may be configured to prioritize the measurement gap for certain PDUs while correspondingly discarding those PDUs. For example, for PDUs which have a lower importance level, the measurement gap engine 624 may be configured to discard those PDUs and perform an RRM measurement during a measurement gap in which whose PDUs could otherwise have been sent.

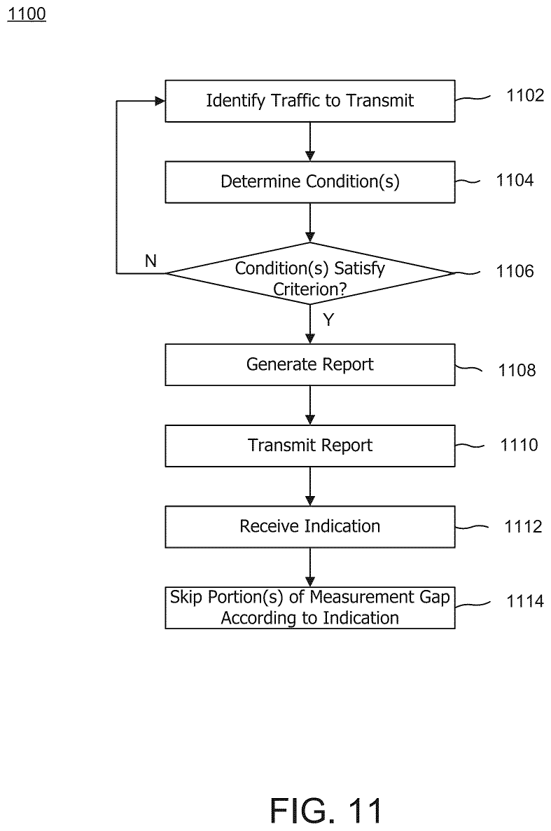

FIG. 11 is a flowchart showing an example method 1100 for adaptive use of measurement gaps, according to another example implementation of the present disclosure. The method 1100 may be performed by the devices, components, elements, or hardware described above with reference to FIG. 1-FIG. 10. As a brief overview, at step 1102, a wireless communication device may identify traffic to transmit. At step 1104, the wireless communication device may determine one or more conditions. At step 1106, the wireless communication device may determine whether the condition(s) satisfy a threshold criterion. At step 1108, the wireless communication device may generate a report. At step 1110, the wireless communication device may transmit the report. At step 1112, the wireless communication device may receive an indication. At step 1114, the wireless communication device may skip portion(s) of measurement gap(s) according to the indication.

At step 1102, a wireless communication device may identify traffic to transmit. In some embodiments, the wireless communication device may identify various types of traffic which is to be transmitted to a wireless communication node. The traffic may be or include extended reality (XR) traffic. In some embodiments, the wireless communication device may identify traffic which is to be transmitted based on grant requests, scheduled grants, information from buffers of the wireless communication device, and/or signals/indicators from an application executing on or supported by the wireless communication device.

At step 1104, the wireless communication device may determine one or more conditions. In some embodiments, the wireless communication device may determine, e.g., conditions of the device, such as cellular conditions of the device, movement data of the device, and/or traffic conditions of the device. For example, the wireless communication device may determine the cellular conditions of the device, by determining, e.g., the proximity of the device to a central portion of a cellular coverage area. The wireless communication device may determine the proximity of the device to the central portion of the cell coverage area of the wireless communication node, based on various parameters including, but not limited to, signal strength, signal-to-noise ratio (SNR), and timing advance (TA) values associated with communications between the device and a serving base station. In some embodiments, the wireless communication device may determine additional and/or alternative cellular conditions, such as levels of interference from neighboring cells, connection quality metrics (e.g., packet error rate or bit error rate), or channel quality indicators (CQIs).

In some embodiments, the wireless communication device may determine movement conditions/information/data of the device. For example, the wireless communication device may determine or identify intra-cell movement metrics and/or inter-cell movement metrics. The wireless communication device may determine the intra-cell movement metrics based on, e.g., local sensor data (e.g., gyroscope and/or accelerometers). The wireless communication device may determine the inter-cell movement metrics based on changes in the cellular conditions (e.g., which indicate a potential change in cell).

In some embodiments, the wireless communication device may determine traffic conditions of the device. The wireless communication device may determine the traffic condition(s), based on a packet delay budget (PDB), data rate, packet loss rate, importance level, etc. The wireless communication device may determine the traffic condition(s) based on various metrics of the wireless communication link (e.g., a 5QI value for a data pipe which is carrying the traffic, a QoS requirement for the traffic, etc.). In some embodiments, the wireless communication device may determine traffic conditions of PDUs and/or PDU sets. For example, the wireless communication device may identify an importance of respective PDU sets (and/or PDUs of a PDU set), which are to be sent to the wireless communication node.

At step 1106, the wireless communication device may determine whether the condition(s) satisfy a threshold criterion. In some embodiments, the wireless communication device may compare the condition(s) to respective threshold criterion, to determine whether or not to request to skip at least a portion of measurement gap. The threshold criterion may be dependent on the particular condition against which the threshold criterion is applied. For example, the wireless communication device may compare the packet delay budget of traffic to a threshold packet delay budget, and the criterion may be satisfied where the packet delay budget is less than (or less than or equal to) the threshold packet delay budget. As another example, the wireless communication device 602 may compare the data rate of traffic to a threshold data rate, and the criterion may be satisfied where the data rate is greater than (or greater than or equal to) the threshold data rate. As yet another example, the wireless communication device 602 may compare the packet loss rate of traffic to a threshold packet loss rate, and the criterion may be satisfied where the packet loss rate is less than (or less than or equal to) the threshold packet loss rate. As still another example, the wireless communication device 602 may compare the importance of traffic to a threshold importance level, and the criterion may be satisfied where the importance level is greater than (or greater than or equal to) the threshold importance level. As a further example, the wireless communication device 602 may determine its location within the coverage area of the wireless communication node 606 and compare its proximity to the cell center against a threshold range or percentage of the cell radius. The criterion may be satisfied where the wireless communication device 602 is within the threshold range or percentage of the cell center. As another example, the wireless communication device 602 may determine its mobility level and compare it to a threshold mobility level, and the criterion may be satisfied where the mobility level is less than (or less than or equal to) the threshold mobility level.

Where, at step 1106, the wireless communication device determines that the condition satisfies a threshold criterion, the method may proceed to step 1108. On the other hand, where the wireless communication device determines that the condition does not satisfy the threshold criterion, the method may proceed back to step 1102.

At step 1108, the wireless communication device may generate a report. In some embodiments, the wireless communication device may generate the report to indicate, identify, or otherwise provide one or more of the condition(s). In some embodiments, the wireless communication device may generate the report by configuring various types or forms of messages or signals, such as RRC messages, UCI messages, NAS messages, and/or scheduling requests. At step 1110, the wireless communication device may transmit the report. IN some embodiments, the wireless communication device may transmit the report (e.g., including the condition(s) of the wireless communication device) to the wireless communication node. The wireless communication device may transmit the report to the wireless communication node, to request to skip at least a portion of a measurement gap. In other words, the wireless communication device may transmit a request to skip a measurement gap (or portion thereof), where the request includes conditions and/or is otherwise configured as a report including those conditions.

At step 1112, the wireless communication device may receive an indication. In some embodiments, the wireless communication device may receive, from the wireless communication node, an indication based on the one or more conditions. The wireless communication device may receive the indication responsive to the wireless communication node (or wireless communication system/core network) analyzing the report/request and condition(s) of the wireless communication device. The wireless communication device may receive the indication, to indicate whether the wireless communication device is permitted to modify/adapt the measurement gap pattern according to the condition(s) of the device.

At step 1114, the wireless communication device may skip portion(s) of measurement gap(s) according to the indication. In some embodiments, the wireless communication device may selectively skip portion(s) of a measurement gap for a radio resource management (RRM) measurement, according to the indication. For example, the wireless communication device may skip portion(s) of a measurement gap, by reducing a gap duration or a periodicity of a measurement gap pattern. As another example, the wireless communication device may skip portion(s) of a measurement gap, by deactivating the measurement gap. In some embodiments, the wireless communication device may transmit traffic to the wireless communication node during the portion of the measurement gap, responsive to skipping the portion. In other words, the wireless communication device may transmit traffic in the temporal portion or window in which the RRM measurement was scheduled in the measurement gap, responsive to skipping that temporal portion or window.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

1. A method, comprising:
transmitting, by a wireless communication device to a wireless communication node, a report comprising one or more conditions of the wireless communication device;
receiving, by the wireless communication device from the wireless communication node, an indication based on the one or more conditions; and
selectively skipping, by the wireless communication device, at least a portion of a measurement gap of a radio resource management (RRM) measurement, according to the indication.

2. The method of claim 1, wherein the one or more conditions comprise at least one of cellular conditions of the wireless communication device, movement data of the wireless communication device satisfying a threshold criterion, or a priority of traffic of the wireless communication device.

3. The method of claim 1, wherein transmitting the report is responsive to determining to transmit traffic to the wireless communication node.

4. The method of claim 3, wherein the traffic comprises extended reality (XR) traffic, further comprising:
determining, by the wireless communication device, at least one quality of service (QOS) metric of the XR traffic, the QoS metric comprising at least one of a time sensitivity, a data rate, or reliability metric; and
transmitting, by the wireless communication device, the report responsive to the QoS metric satisfying a threshold criterion.

5. The method of claim 1, further comprising:
transmitting, by the wireless communication device, traffic to the wireless communication node during the portion of the measurement gap, responsive to skipping the portion.

6. The method of claim 1, further comprising:
transmitting, by the wireless communication device, the report responsive to determining to transmit traffic and at least one of:
the traffic having a packet delay budget (PDB) less than a threshold PDB;
the traffic having a data rate which is greater than a threshold data rate;
the traffic having a packet loss rate which is less than a threshold packet loss rate;
the traffic having an importance level which is greater than a threshold importance;
a location of the wireless communication device being associated with a central portion of a coverage area of the wireless communication node; or
a movement of the wireless communication device being less than a threshold mobility.

7. The method of claim 1, wherein selectively skipping the portion of the measurement gap comprises reducing a gap duration or a periodicity of a measurement gap pattern.

8. The method of claim 1, wherein selectively skipping the portion of the measurement gap comprises deactivating the measurement gap.

9. The method of claim 8, further comprising:
identifying, by the wireless communication device, for a plurality of protocol data unit (PDU) sets, an importance of the respective PDU sets, to be sent to the wireless communication node; and
selectively skipping, by the wireless communication device, at least a portion of a measurement gap, responsive to the importance of at least one PDU set being greater than a threshold.

10. The method of claim 9, wherein the wireless communication device skips the portion of the measurement gap responsive to the at least one PDU set being in a buffer for transmission uplink, and the portion of the measurement gap which is skipped by the wireless communication corresponds to a time instance in which the PDU set is sent uplink.

11. A wireless communication device, comprising:
a transceiver; and
one or more processors configured to:
transmit, via the transceiver to a wireless communication node, a report comprising one or more conditions of the wireless communication device;
receive, via the transceiver from the wireless communication node, an indication based on the one or more conditions; and
selectively skip at least a portion of a measurement gap of a radio resource management (RRM) measurement, according to the indication.

12. The wireless communication device of claim 11, wherein the one or more conditions comprise at least one of cellular conditions of the wireless communication device, movement data of the wireless communication device satisfying a threshold criterion, or a priority of traffic of the wireless communication device.

13. The wireless communication device of claim 11, wherein transmitting the report is responsive to determining to transmit traffic to the wireless communication node.

14. The wireless communication device of claim 13, wherein the traffic comprises extended reality (XR) traffic, wherein the one or more processors are further configured to:
determine at least one quality of service (QOS) metric of the XR traffic, the QoS metric comprising at least one of a time sensitivity, a data rate, or reliability metric; and
transmit the report responsive to the QoS metric satisfying a threshold criterion.

15. The wireless communication device of claim 11, wherein the one or more processors are configured to:
transmit, via the transceiver, traffic to the wireless communication node during the portion of the measurement gap, responsive to skipping the portion.

16. The wireless communication device of claim 11, wherein the one or more processors are further configured to:
transmit the report responsive to determining to transmit traffic and at least one of:
the traffic having a packet delay budget (PDB) less than a threshold PDB;
the traffic having a data rate which is greater than a threshold data rate;
the traffic having a packet loss rate which is less than a threshold packet loss rate;
the traffic having an importance level which is greater than a threshold importance;
a location of the wireless communication device being associated with a central portion of a coverage area of the wireless communication node; or a movement of the wireless communication device being less than a threshold mobility.

17. The wireless communication device of claim 11, wherein selectively skipping the portion of the measurement gap comprises reducing a gap duration or a periodicity of a measurement gap pattern.

18. The wireless communication device of claim 11, wherein selectively skipping the portion of the measurement gap comprises deactivating the measurement gap.

19. The wireless communication device of claim 18, wherein the one or more processors are further configured to:
identify, for a plurality of protocol data unit (PDU) sets, an importance of the respective PDU sets, to be sent to the wireless communication node; and
selectively skip at least a portion of a measurement gap, responsive to the importance of at least one PDU set being greater than a threshold.

20. A non-transitory computer readable medium storing instructions that, when executed by one or more processors, cause the one or more processors to:
transmit, via a transceiver to a wireless communication node, a report comprising one or more conditions of a wireless communication device;
receive, via the transceiver from the wireless communication node, an indication based on the one or more conditions; and
selectively skip at least a portion of a measurement gap of a radio resource management (RRM) measurement, according to the indication.
